(19) United States
(12) Patent Application Publication
(10) Pub. No.: US 2026/0355047 A1
(43) Pub. Date: Nov. 12, 2026

(54) HEALTHCARE DEVICE WITH BELT

(71) Applicant: Dongguan Xilijian Technology Co., Ltd., Dongguan City (CN)

(72) Inventor: CHANGXI HU, Dongguan City (CN)

(21) Appl. No.: 19/530,377

(22) Filed: Feb. 5, 2026

(30) Foreign Application Priority Data
May 8, 2025 (CN) 202520896607.6

(51) Int. Cl. A61H 9/00; A61H 23/02

(52) U.S. Cl. CPC A61H 9/0085; A61H 9/0092; A61H 23/02; A61H 2201/0228; A61H 2201/10; A61H 2201/1238; A61H 2201/165; A61H 2201/169; A61H 2201/5046

(57) ABSTRACT

A healthcare device with belt includes a belt body configured for wrapping around a user body, an airbag assembly, a control device and an inflation and deflation component. The airbag assembly is inflatable and deflatable, and comprises at least one first airbag arranged on the belt body, and at least one second airbag arranged on the at least one first airbag. The control device is arranged on the belt body and exposed to outside, and the inflation and deflation component is arranged on the belt body and connected to the airbag assembly, and the inflation and deflation component is configured for inflating or deflating the airbag assembly based on a user’s control of the control device.

### CROSS-REFERENCE TO RELATED APPLICATIONS

The present application claims a priority of Chinese patent application CN 202520896607.6, filed on May 8, 2025, the entire disclosures of which are incorporated herein by reference.

### TECHNICAL FIELD

The present application relates to the field of healthcare technology, particularly to a healthcare device with belt.

### BACKGROUND

With the continuous development of society and the improvement of living standards, people are paying more and more attention to their own health issues, and healthcare devices with belt, such as knee healthcare belts, elbow healthcare belts, waist healthcare belts, etc, have the functions of exercise protection, cold insulation, joint care, etc., and are widely used in medical care and other fields, among which belts with airbags are particularly popular due to their advantages of relieving joint pressure, providing support, and correcting posture.

The existing airbag waistbands often encounter the following problems during use, specifically, the airbags in the waistband are usually single-layer structures, during the cyclic inflation and deflation process, the maximum expansion thickness and massage pressure are limited, making it difficult to achieve deep muscle massage; and limited by the structure of the airbag itself, airbags usually have thinner edges and thicker middle after inflation, it is difficult to uniformly fit the curved human waist, resulting in uneven pressure distribution on the human waist and affecting the massage effect.

### SUMMARY

To solve the above problems, the present utility model provides a belt that can increase the overall expansion thickness of the airbag, stabilize the position of the vibrator, and improve the vibration transmission rate of the vibrator; it can also increase the support area, support force, and vibration range of the belt for the human waist.

A healthcare device with belt comprises a belt body configured for wrapping around a user body, an airbag assembly, a control device and an inflation and deflation component. The airbag

assembly is inflatable and deflatable, and comprises at least one first airbag arranged on the belt body, and at least one second airbag arranged on the at least one first airbag. The control device is arranged on the belt body and exposed to outside, and the inflation and deflation component is arranged on the belt body and connected to the airbag assembly, and the inflation and deflation component is configured for inflating or deflating the airbag assembly based on a user’s control of the control device.

Compared to existing technologies, due to the parallel double-layer airbag structure of the first airbag and the second airbag, compared to the single-layer airbag, the expansion thickness is larger and the adjustment range of massage pressure is wider;

the vibrator is located in the second airbag which is closer the waist of the human body, the inflation of the first airbag and the second airbag can generate greater pressure on the vibrator, and the easily deformable second airbag can wrap around the vibrator after inflation, effectively preventing the vibrator from shaking back and forth, making it more stable, and reducing the loss of vibration energy during transmission to the waist of the human body, thereby improving the vibration transmission rate of the vibrator;

due to the fact that the second inflation can closely adhere to the waist of the human body, compared to vibrators with significantly smaller areas, it can increase the support area and force of the belt on the human body. In addition, the vibration of the vibrator can be sequentially transmitted to the second airbag and the waist of the human body, thus increasing the vibration range of the belt;

Overall, by using this belt, the overall expansion thickness of the airbag can be increased, the position of the vibrator can be stabilized, and the vibration transmission rate of the vibrator can be improved; it can also increase the support area, support force, and vibration range of the belt for the human waist.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

FIG. 1 is a schematic perspective view of a healthcare device with belt according to an embodiment of the present disclosure.

FIG. 2 is another schematic perspective view of the healthcare device with belt of FIG. 1.

FIG. 3 is an exploded view of the healthcare device with belt of FIG. 3.

FIG. 4 is a perspective view showing one side of the belt having airbag assemblies after inflation.

FIG. 5 is a perspective view showing another side of the belt having airbag assemblies after inflation.

FIG. 6 is partially cut away view of FIG. 5.

FIG. 7 shows a vibrator mounted in the airbag assemblies.

FIG. 8 is an exploded view of the vibrator of FIG. 7.

FIG. 9 is a schematic perspective view showing an inflation and deflation component.

FIG. 10 is a schematic perspective view showing a multi connector of FIG. 9.

FIG. 11 shows an air pump and a solenoid valve in a lower shell of FIG. 1.

FIG. 12 is an exploded view of a control device of FIG. 1.

FIG. 13 is another view of FIG. 12.

FIG. 14 shows one side of the belt having the airbag assemblies after deflation.

FIG. 15 shows another side of the belt having the airbag assemblies after deflation.

FIG. 16 is an exploded view of a heating component.

FIG. 17 is an exploded view of a healthcare device with belt according to a modified embodiment of the present disclosure.

FIG. 18 is a partially assembled view of the healthcare device with belt of FIG. 17.

FIG. 19 is an enlarged view of A part of FIG. 18.

FIG. 20 is a schematic perspective view of a connecting pipe of the healthcare device with belt of FIG. 17.

FIG. 21 is a schematic perspective view of a connecting joint of the healthcare device with belt of FIG. 17.

FIG. 22 is a cut away view of the connecting joint of FIG. 21.

### DRAWING REFERENCES

Elements and References:
belt body 1;
first airbag assembly 2;
second airbag assembly 3;
first airbag 21;
second airbag 31;
groove 311;
first cover 101;
second cover 102;
first fixing portion 103;
second fixing portion 104;
vibration component 4;
vibrator 41;
inflation and deflation component 5;
air pump 51;
multi connector 52;
electromagnetic valves 53;
first air delivery pipe 54;
second air delivery pipe 55;
control device 6;
housing 61;
upper housing 611;
lower housing 612;
touch screen display 62;
power supply 64;
switch 65;
charging port 66;
third airbag assembly 7;
third airbag 71;
heating component 8;
elastic member 9;
connection seat 10;
perforation 11;
airbag assembly 20;
spring member 50;
connecting pipe 30;
electric heating wire
81; heat-resistant
fabric layer 82;
first thermal insulation layer 1011a,
second thermal insulation layer 1011b,
third thermal insulation layer 1011c,
fourth thermal insulation layer 1011d;
edge wrapping 1012;
covering layer 1013;
connecting joint 70;
first joint 74;
second joint 72;
mounting plate 73;
connecting hole 731.

### DETAILED DESCRIPTION OF THE EMBODIMENTS

The accompanying drawings in the embodiment of the present disclosure are combined, The technical scheme in the embodiment of the present disclosure is clearly and completely described, Obviously, the described embodiment is only a part of the embodiment of the present disclosure, but not all embodiments are based on the embodiment of the present disclosure, and all other embodiments obtained by ordinary technicians in the field on the premise of not doing creative work belong to the protection range of the present disclosure.

In order to make the above objectives, features, and advantages of the present application more obvious and understandable, the following will provide further detailed explanations of the present application in conjunction with the accompanying drawings and specific implementation methods.

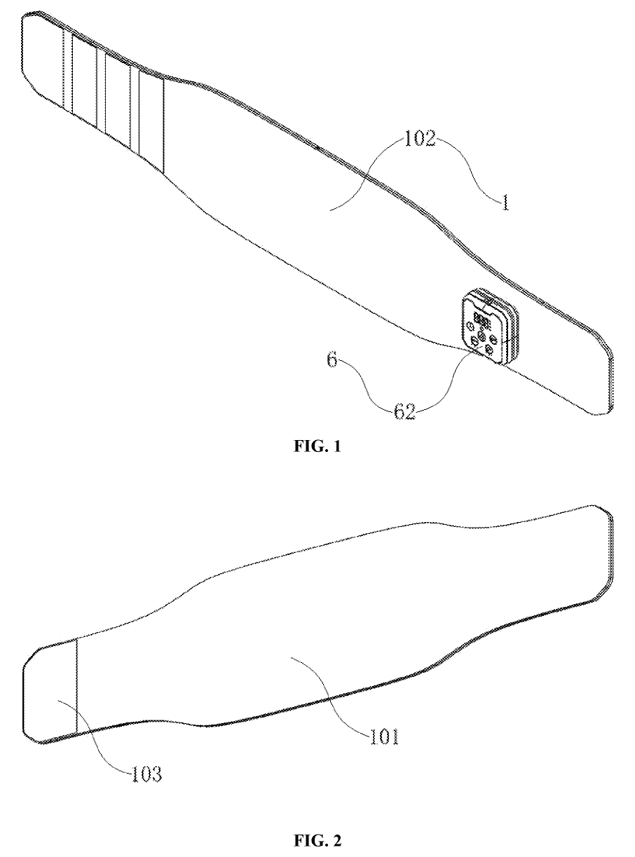

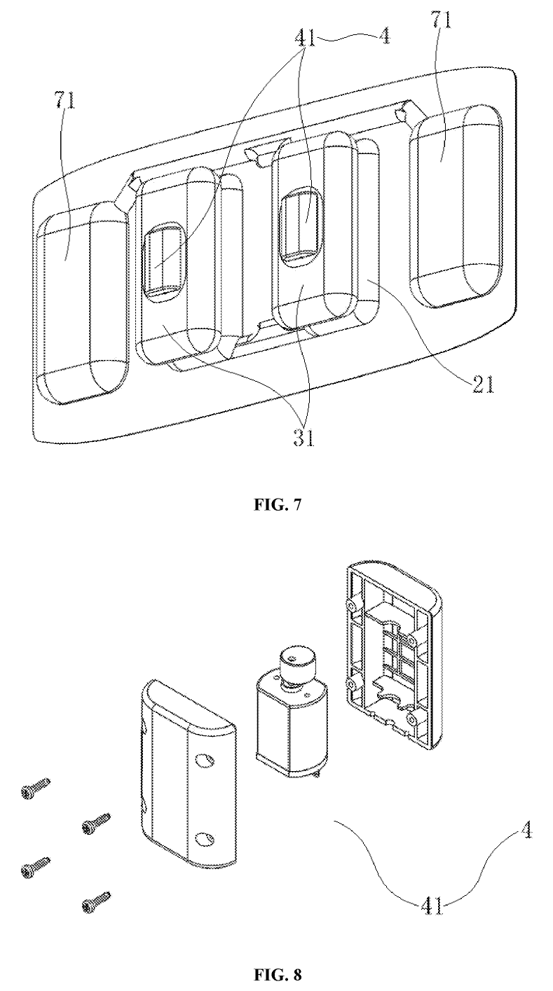

Referring to FIGS. 1-7, as well as FIGS. 14 and 15, the present embodiment of the utility model discloses a healthcare device with belt, including a belt body 1 made of flexible material for wrapping around a user body, such as a human waist. The belt body 1 is provided with an airbag assembly, and the airbag assembly at least includes a first airbag assembly 2 and a second airbag assembly 3 in this embodiment. The first airbag assembly 2 includes at least one first airbag 21 arranged on the belt body 1, and the second airbag assembly 3 includes at least one second airbag 31 arranged on the at least one first airbag 21, with the second airbag 31 on the side closer to the user. Each second airbag 31 is provided with a vibration component 4 therein, and each vibration component 4 comprises at least one vibrator 41.

The belt body 1 is also equipped with an inflation and deflation component 5 and a control device 6, the control device 6 is exposed to outside for facilitating a user’s control. The inflation and deflation component 5 is used to control the inflation and deflation of the first airbag assembly 2 and the second airbag assembly 3, while the control device 6 is used to control the start and stop of the vibration component 4 and working of the inflation and deflation component 5.

In actual use, wrap the belt body 1 around a human waist and fix it at the human waist, then control the start and stop of the vibrator 41 in the vibration component 4 and the inflation and deflation component 5 through the control device 6, and then control inflation and deflation of the first airbag 21 in the first airbag assembly 2, and inflation and deflation of the second airbag 31 in the second airbag assembly 3 through the inflation and deflation component 5, so that the belt body 1 can massage the human waist.

Due to the parallel double-layer airbag structure of the first airbag 21 and the second airbag 31, compared to single-layer airbags, the expansion thickness is larger and the adjustment range of massage pressure is wider.

The vibrator 41 is located in the second airbag 31 and is closer to the waist of the human body, inflation of the first airbag 21 and the second airbag 31 generate pressure on the vibrator 41, and the second airbag 31 deforms to wrap around the vibrator 41, effectively preventing the vibrator 41 from shaking back and forth, making it more stable, and reducing the loss of vibration energy during transmission to the waist of the human body, thereby improving the vibration transmission rate of the vibrator 41.

Due to the fact that the second airbag 31 can closely adhere to the human waist after inflation, compared to the vibrator 41 with a significantly smaller area, it can increase the support area and force of the belt on the human waist.

In addition, the vibration of the vibrator 41 can be sequentially transmitted to the second airbag 31 and the human waist, thus increasing the vibration range of the belt body 1.

Overall, by using this belt body 1, the overall expansion thickness of the airbag can be increased, the position of vibrator 41 can be stabilized, and the vibration transmission rate of vibrator 41 can be improved, this can also increase the support area, support force, and vibration range of the belt for the human waist.

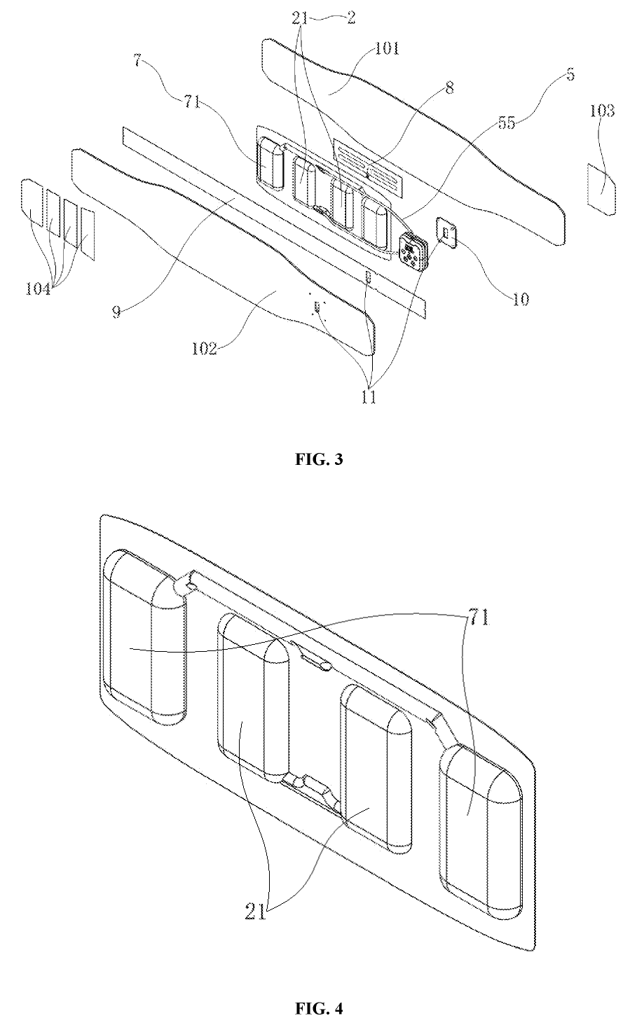

Referring to FIGS. 3-7, it should be noted that since the specific number and installation positions of the first airbag 21, the second airbag 31, and the vibrator 41 are not limited in this application, they can be flexibly designed according to actual needs. For example, since the middle of the human back waist is a concave structure, and the airbag is usually difficult to massage this area, the at least one first airbag 21 can be two first airbags 21 corresponding to the left and right sides of the human back waist to avoid resource waste; the at least one second airbag 31 can be two second airbags 31 arranged on the two first airbags 21. The at least one vibrator 41 can be two vibrators 41 arranged in the middle of the two second airbags 31, so that the second airbag 31 can more evenly and thoroughly wrap around the corresponding vibrator 41 therein.

Referring to FIG. 8, it should be noted that the type of vibrator 41 is not limited in this application, and can be flexibly selected according to actual needs. The vibrator 41 in this embodiment is preferably an eccentric vibrator.

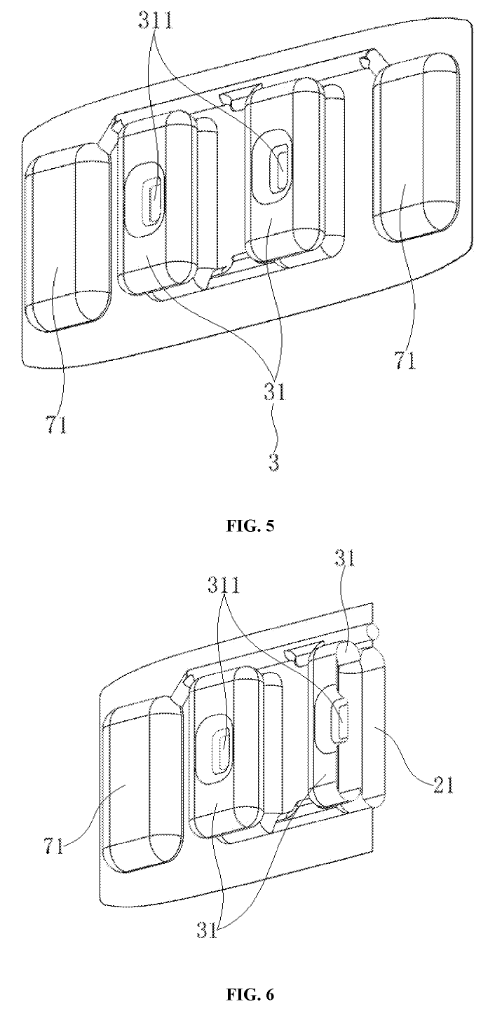

Referring to FIGS. 5-7, furthermore, a groove 311 corresponding to the vibrator 41 can be provided in the second airbag 31 to enable the second airbag 31 to more evenly and thoroughly wrap around the vibrator 41.

Based on the above scheme, as the belt body 1 has both airbag massage and vibration massage functions, it has three usage modes, specifically:
1. Only using airbag massage: when in use, by cyclically inflating and deflating the first airbag assembly 2 and the second airbag assembly 3, a cyclic pressure wave can be generated, and the physical massage action of "press-release" can be simulated. The massage speed can be adjusted according to the inflation and deflation speed, and the massage pressure can be adjusted according to the amount of inflation. During the massage process, a gradient pressure can be formed to promote blood flow, which can act on deep muscles. The noise during use is smaller, and the massage action is softer and smoother, with higher comfort.
2. Only vibration massage is used: when in use, the first airbag assembly 2 and the second airbag assembly 3 are inflated and continuously maintained in this state without cyclically inflating and deflating, at this time, the vibration component 4 will be pressed tightly against the waist. The vibrator 41 can be activated to generate high-frequency mechanical vibration. The vibration mode is relatively simple and can simulate the physical massage action of "tapping or kneading". The massage speed can be adjusted according to the vibration frequency of the vibrator, and the massage pressure can be adjusted according to the vibration amplitude of the vibrator. During the massage process, energy is concentrated on the local surface tissue, which can stimulate muscles and nerve endings. The noise is higher during use, and the massage action is more intense with stronger vibration sensation.
3. Simultaneously use airbag massage and vibration massage: when in use, inflate and inflate the first airbag assembly 2 and the second airbag assembly 3, and press the vibration component 4 tightly against the waist, then, without affecting the fixation of the vibration component 4, cycle the inflation and deflation of the first airbag assembly 2 and the second airbag assembly 3, and activate the vibrator 41 for high-frequency mechanical vibration. In this vibration mode, compared to using only airbags for massage, the massage intensity can be increased and the massage mode can be increased, allowing the waist to receive continuous massage and producing faster and better results; compared to using only vibration massage, it can increase the massage range and mode, and make the massage intensity present a gradient change, resulting in higher comfort.

Referring to FIGS. 1-3, in order to enable the belt body 1 to wrap around the waist of the human body, the following design has been made in this embodiment. Specifically, the belt body 1 includes a first cover 101 and an opposite second cover 102. The first cover 101 and the second cover 102 can be made of cloth which has the flexible property. The first cover 101 is located on one side of the belt body 1 near the waist of the human body, and is basically in the shape of a long strip with a first fixing portion 103 on the side near the waist of the human body; the second cover 102 is located on the side of the belt body 1 away from the waist of the human body and is connected to the first cover 101. The second cover 102 is basically in the shape of a long strip and has a second fixing portion 104 on the side away from the waist of the human body. In present embodiment, the first fixing portion 103 and the second fixing portion 104 are Velcro tape, and the first cover 101 and the second cover 102 can be connected by Velcro force the first fixing portion 103 and the second fixing portion 104, so as to wrap and fix the belt body 1 around the waist of the human body. The first airbag assembly 2, the second airbag assembly 3, and the vibration component 4 are all set between the second cover 102 and the first cover 101.

Through the design of the above structure, the first cover 101 can be wrapped around the waist, and then the first fixing portion 103 on the first cover 101 can be connected to the second fixing portion 104 on the second cover 102 through adhesive connection, thus wrapping and fixing the belt body 1 around the waist of the human body. Due to the simple planar structure and deformability of the first fixing portion 103 and second fixing portion 104, it will not significantly affect the structure and thickness of the belt body 1 in its unused state, nor will it significantly affect the ability of the belt body 1 to wrap and deform during use; and due to the fact that the first fixing portion 103 and the second fixing portion 104 can be connected by pressing, and can be disconnected by pulling, it is more convenient to disassemble and use; and due to the fact that both the first fixing portion 103 and the second fixing portion 104 have a certain length, and any part of the first fixing portion 103 and the second fixing portion 104 can be connected by adhesive buckle, the length of the belt body 1 after winding can be flexibly adjusted according to the actual waist circumference of the human body, with a wider range of applications and higher comfort.

It should be noted that the present application does not limit the structure, material, size, color, or detachable connection method for wrapping and fixing the belt body 1. The above cloth cover structure and Velcro connection are only examples; other detachable connections can be made, snap fasteners, snap fasteners, etc. can also be used; In addition, this embodiment does not limit the first fixing portion 103 and the second fixing portion 104, and can be designed according to actual needs. For example, the first fixing portion 103 can be designed as a hook surface and the second fixing portion 104 can be designed as a hair surface. At this time, the hook surface can avoid scratching the arm outward; alternatively, the first fixing portion 103 can be designed as a matte surface, and the second fixing portion 104 can be designed as a hook surface, which can prevent the hook surface from scratching the waist inward.

Referring to FIGS. 3-7, when the first airbag assembly 2 includes at least two first airbags 21, the following design is carried out in this embodiment. Specifically, the at least two first airbags 21 are interconnected.

Through the design of the above structure, it is possible to balance the air pressure inside different first airbags 21 and enhance stability. It is also possible to reduce the number of pipelines required to deliver air to the first airbag 21, thereby simplifying the structure and reducing the overall weight of the belt.

When the second airbag assembly 3 includes at least two second airbags 31, the following design is carried out in this embodiment, specifically, the at least two second airbags 31 are interconnected.

Through the design of the above structure, it is possible to balance the air pressure inside different second airbags 31 and enhance stability, so that the vibrator 41 and the waist of the human body are evenly stressed. It is also possible to reduce the number of pipelines required to deliver air to the second airbag 31, thereby simplifying the structure and reducing the overall weight of the belt.

It should be noted that the above "the first airbags 21 are interconnected, and the second airbags 31 are interconnected" include various interconnection (i.e., in communication) methods, specifically:
1. The first airbags 21 are directly interconnected; and the second airbags 31 are directly interconnected. At this time, the first airbag 21 and the corresponding second airbag 31 can be interconnected or independent from each other;
2. The first airbags 21 are directly interconnected; and each of the second airbags 31 is interconnected to one of the first airbags 21, thereby the second airbags 31 are indirectly interconnected. This connection method is adopted in this embodiment, as shown in FIGS. 5 and 6;
3. The second airbags 31 are directly interconnected, and each of the first airbags 21 is interconnected to one of the second airbags 31, thereby the first airbags 21 are indirectly interconnected.

Referring to FIGS. 5 and 6, further designs have been made in this embodiment. Specifically, the first airbag 21 and the second airbag 31 are interconnected to enhance the cushioning performance of the waistband.

Through the design of the above structure, during the vibration of the vibrator 41, the air in the second airbag 31 can flow to the first airbag 21, which can effectively avoid local pressure surges or overload causing airbag rupture. In addition, the air will enhance energy dissipation during the flow process, absorb impact better, and have stronger buffering performance, making the non massage area on the belt less sensitive and more comfortable to wear.

Referring to FIGS. 3-7, in order to increase the support effect of the belt, the following design has been carried out in this embodiment. Specifically, the first airbag assembly 2 and the second airbag assembly 3 are arranged in the middle of the belt body 1, which can support the back of the human waist through inflation and massage the back of the human waist through cyclic inflation and deflation; It also includes a third airbag assembly 7, which is arranged on the belt body 1. The third airbag assembly 7 includes at least one set of inflatable and deflated third airbags 71, each set of third airbags 71 includes two third airbags 71 and is symmetrically arranged relative to the first airbag assembly 2.

Through the design of the above structure, the third airbag assembly 7 can support the left and right sides of the human waist after inflation, correct sitting posture, and massage the left and right sides of the human waist through cyclic inflation and deflation.

Furthermore, all of the third airbags 71 can be interconnected to make the force on the waist of the human body more uniform, or the third airbags 71 can be interconnected to the first airbags 21 or interconnected to the second airbags 31. In addition, the number of pipelines required to deliver air to the third airbag 71 can be reduced, simplifying the structure and reducing the overall weight of the belt.

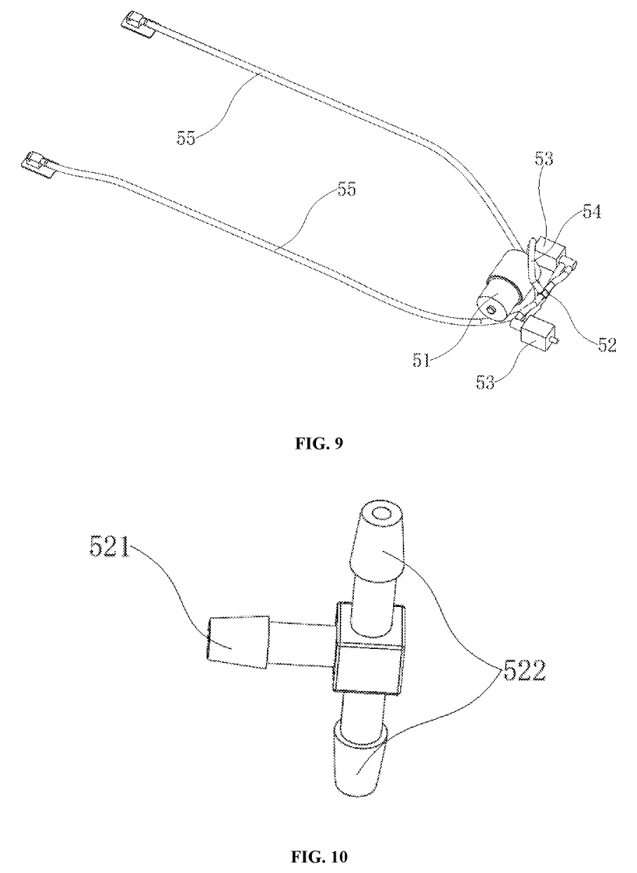

Referring to FIGS. 3 and 9-11, in order to enable the inflation and deflation module 5 to inflate and deflate the first airbag assembly 2 and the second airbag assembly 3, the following design is carried out in this embodiment. Specifically, the inflation and deflation module 5 includes an air pump 51, a multi connector 52, and multiple electromagnetic valves 53. The air pump 51 has blowing and suction functions, and is electrically connected to the control device 6 for controlling the start stop and function switching of the air pump 51. The air pump 51 comprises a first air delivery pipe 54 and multiple second air delivery pipe 55, and the multiple second air delivery pipe 55 each extend the airbags. The multi port connector 52 includes an air inlet 521 and multiple air outlets 522, the air inlet 521 is connected to the air pump 51 through one first air delivery pipe 54, and the air outlets 522 each are connected to one of the second air delivery pipes 55. The multiple solenoid valves 53 are respectively installed on multiple second air delivery pipes 55 to control the opening and closing of the second air delivery pipes 55, and the multiple solenoid valves 53 are electrically connected to the control device 6 to control the start and stop of the solenoid valves 53 based on control of the control device 6.

The interconnected first airbags 21, interconnected second airbags 31, interconnected third airbags 71, interconnected first airbag 21 and second airbag 31, interconnected first airbag 21 and third airbag 71, interconnected second airbag 31 and third airbag 71, or the interconnected first airbag 21, second airbag 31, and the third airbag 71 can all form a connected chamber. Alternatively, the first airbags 21, the second airbags 31, and the third airbags 71 all can form independent chambers. The connected chamber and the independent chamber are respectively connected to different second air delivery pipes 55, with at least one second air delivery pipe 55 being connected to each connected chamber and each independent chamber.

Through the design of the above structure, each connected chamber and each independent chamber can independently control the air pressure; and in the case where the air flow rate of each second air delivery pipe 55 is the same, the speed of inflation and deflation can be controlled by the number of connected second air delivery pipes 55 between the connected chamber and the independent chamber.

Furthermore, the air pump 51 can be equipped with a vortex air pump, which has both blowing and inhaling functions, making it easy for the air pump 51 to inflate the airbag by inputting air into the airbag or deflate the airbag by outputting the air inside the airbag.

Based on the above scheme, the more chambers that can independently control air pressure, the easier it is to flexibly adjust the air pressure of chambers corresponding to different parts of the waist, with higher degrees of freedom, suitable for people with high sensitivity or waist deformities, etc.

Referring to FIG. 3, in order to enrich the health function of the belt, the following design has been carried out in this embodiment. Specifically, the belt body 1 is equipped with a heating component 8 for physical therapy of the human waist. The heating component 8 is detachably connected to the control device 6.

Furthermore, the heating component 8 uses heating plates that are thin and deformable, which do not significantly affect the appearance structure and winding deformation ability of belt body 1. They also have the advantages of easy installation, no pollution, and long service life.

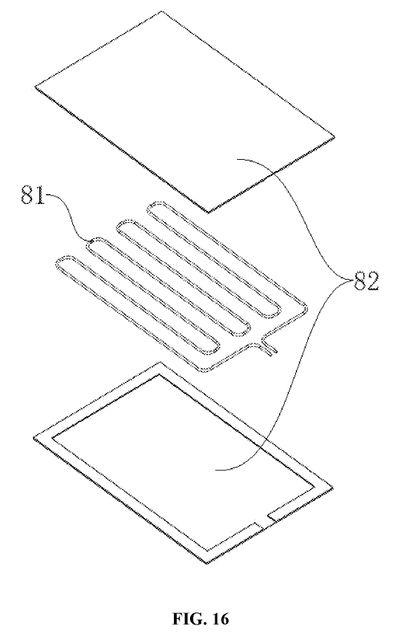

Referring also to FIG. 16, the heating component 8 includes an electric heating wire 81 and two heat-resistant fabric layers 82. The two heat-resistant fabric layers 82 are bonded, and the electric heating wire 81 is arranged in a zigzag pattern and positioned between the two heat-resistant fabric layers 82 to secure its placement and ensure uniform heat distribution.

Referring to FIG. 3, in order to enhance the support effect of the belt body 1, the following design has been carried out in this embodiment. Specifically, the belt body 1 is provided with an elastic member 9.

Through the design of the above structure, the belt body 1 can be more tightly wrapped around the waist of the human body, and the design of the elastic member 9 increases the structural strength of the belt body 1, making it less likely to deform when twisting and bending the waist, thereby increasing the support force and making its support effect better.

Furthermore, the above-mentioned elastic member 9 can be made of PP rubber sheet, memory spring strip, etc.

Referring to FIGS. 1-3, based on the above scheme, this embodiment also includes the following design. Specifically, the belt body 1 further includes a connection seat 10, which is made of rigid material and is located on both sides of the elastic member 9 with the control device 6. The control device 6 includes a housing 61, and the connection seat 10 is fixedly connected to the housing 61.

Through the design of the above structure, the control device 6 is equivalent to being fixed on an elastic member 9 with a certain hardness. Compared to being directly fixed on the softer belt body 1, this method can make the connection of the control device 6 more secure, and the corresponding part of the belt body 1 on the control device 6 is less stressed, making it less likely to tear or break due to pulling.

It should be noted that the "fixed connection" between the connection seat 10 and the housing 61 mentioned above includes detachable and non detachable connections. The detachable connection can be made using threaded connections, snap connections, magnetic connections, etc., while the non detachable connection can be made using adhesive or other methods. In this embodiment, threaded connections are preferred.

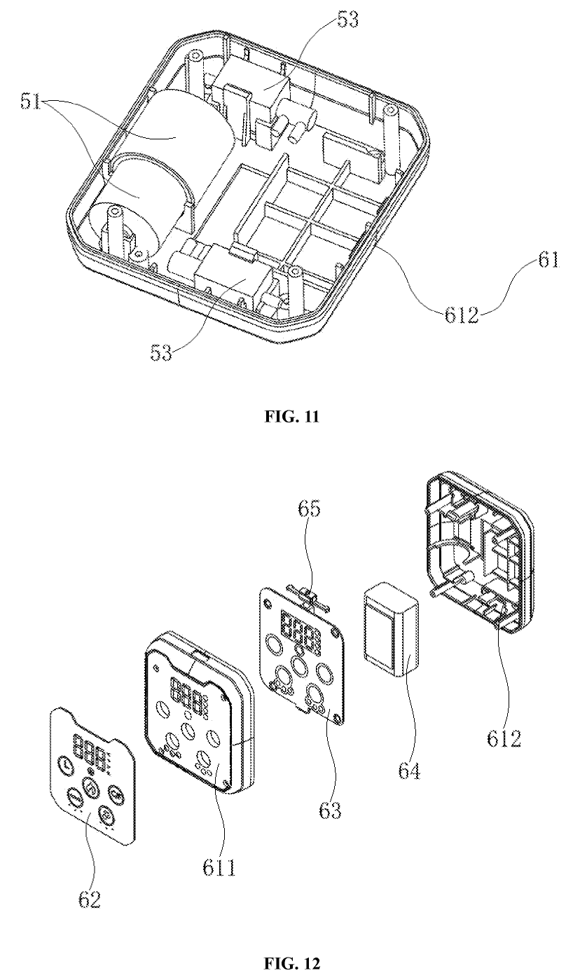

Referring to FIGS. 1, 12, and 13, further, in this embodiment, the control device 6 is designed as follows. Specifically, the control device 6 includes a housing 61, a touch display screen 62, a circuit board 63, a power supply 64, a switch 65, and a charging port 66. The housing 61 includes a detachable upper housing 611 and a lower housing 612, with the lower housing 612 located between the upper housing 611 and the belt body 1, and connected to the belt body 1 through the connection seat 10. The touch display screen 62 is arranged outside the housing 61, and the circuit board 63 and power supply 64 are arranged inside the housing 61. The switch 65 and charging port 66 are arranged on the circuit board 63 and one end of them penetrates the housing 61, allowing users to perform switching and charging operations outside the housing 61. In addition, the vibrator 41, air pump 51, solenoid valve 53, heating component 8, touch screen display 62, power supply 64, switch 65, and charging port 66 are all electrically connected to the circuit board 63, allowing the control device 6 to input commands and display relevant parameters through the touch display screen 62, and then control various electrical components through the circuit board 63. In particular, the touch display screen 62 has functions such as timing, adjusting temperature gear, adjusting temperature display mode, adjusting vibration frequency, adjusting air flow rate, adjusting air flow direction, and displaying various parameters; the switch 65 is a button type structure, used to turn on or off the power supply 64; the charging port 66 adopts a Type-C structure, used to charge the power supply 64; the power supply 64 has functions of energy storage and supply; the circuit board 63 has functions such as detection, temperature induction, and supplying power to the heating component 8 and the vibration component 4.

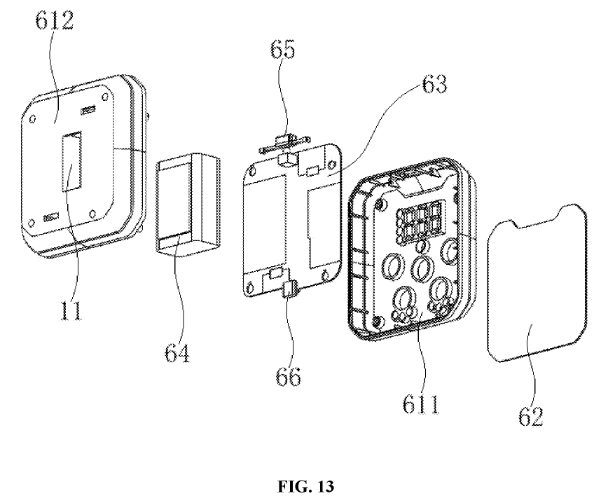

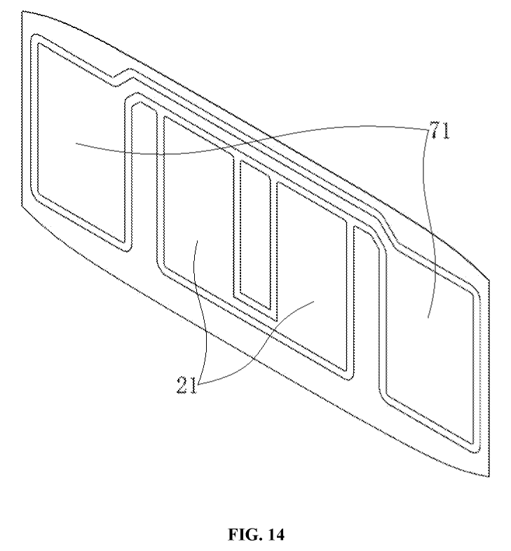

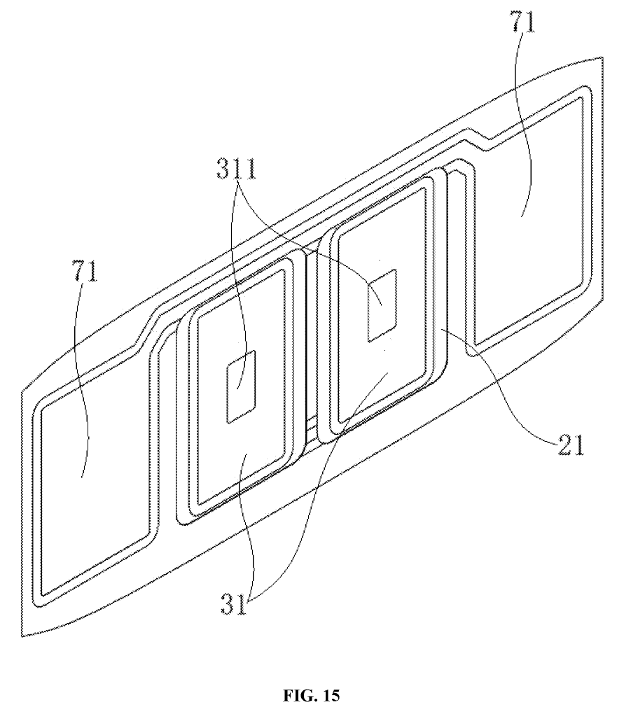

Referring to FIGS. 3 and 13, furthermore, perforations 11 are provided on the second cover 102, lower housing 612, elastic member 9, and connection seat 10 at corresponding positions to allow wires and air tubes in the control device 6 to enter the interior of the belt body 1.

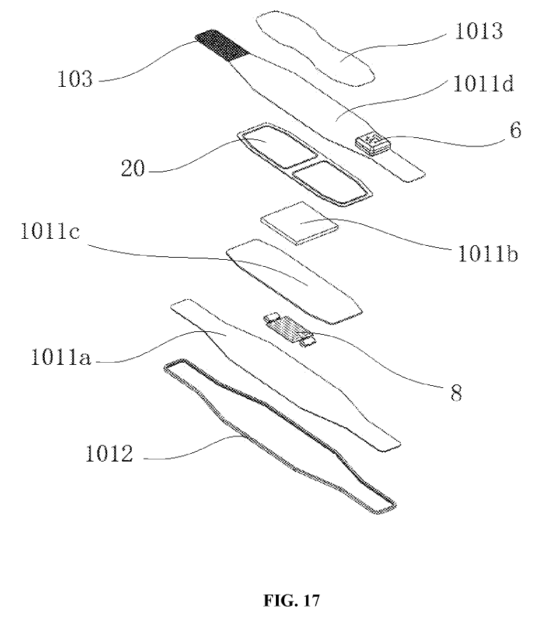

Please refer to FIG. 17, in a modified embodiment, the aforementioned heating component 8 can be sewn onto a thermal insulation component located in the main body 1, in this embodiment, the thermal insulation component includes a first thermal insulation layer 1011a, a second thermal insulation layer 1011b, a third thermal insulation layer 1011c, and a fourth thermal insulation layer 1011d. The first thermal insulation layer 1011a, the second thermal insulation layer 1011b, the third thermal insulation layer 1011c, and the fourth thermal insulation layer 1011d are arranged in parallel in sequence, and the first thermal insulation layer 1011a is closer to the user body. The heating component 8 is sewn onto the second thermal insulation layer 1011b through the two heat-resistant fabric layers 82.

An airbag assembly 20 is located between the third thermal insulation layer 1011c and the fourth thermal insulation layer 1011d. The first thermal insulation layer 1011a and the fourth thermal insulation layer 1011d can be respectively combined with the first cover 101 and the second cover 102 mentioned above, or the first thermal insulation layer 1011a and the fourth thermal insulation layer 1011d respectively form part of the first cover 101 and the second cover 102, i.e., the first cover 101 and the second cover 102 form part of the belt body 1.

Please refer to FIG. 17 again, a covering layer 1013 can be placed on the outer surface of the fourth thermal insulation layer 1011d, that is, the covering layer 1013 is farther away from the user body, which can protect the belt body 1 and also identify the front and back of the healthcare device, making it convenient for users to wear. In addition, since airbags are located inside the belt body 1, it is not convenient to determine the specific position of airbags before inflation, therefore, the covering layer 1013 can also be set corresponding to airbags to identify their positions. The material of the covering layer 1013 can be flexibly selected according to actual needs, such as PU leather, which has the advantages of low price, rich color, and diverse patterns; or PC film, which has the advantages of light transmission, waterproofing, anti-static, easy folding, beauty, etc.

Please refer to FIG. 17 again, furthermore, edge wrapping 1012 can be installed at the edge of the healthcare device, which not only makes the overall structure of the healthcare device more sturdy and less prone to disorder, but also more aesthetically pleasing; and a fixing portion 103 with hook and the matte surface that can be bonded to each other can replace the aforementioned Velcro fixing portions.

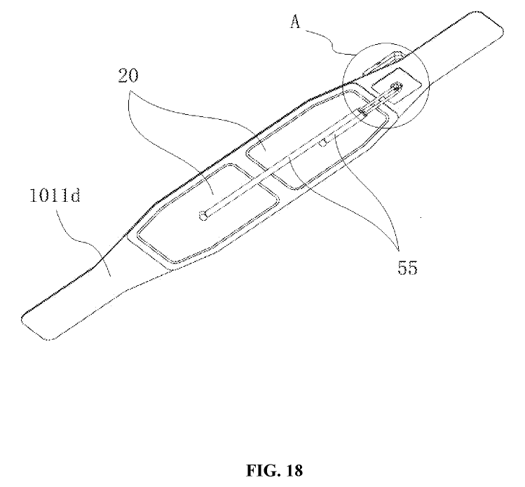

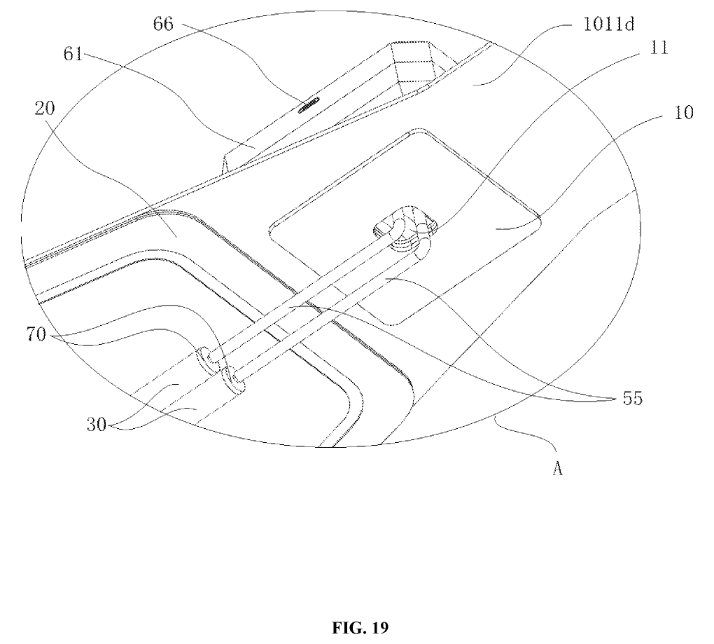

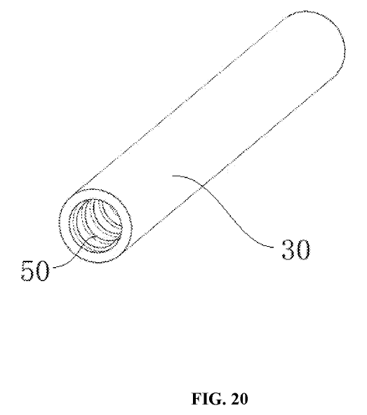

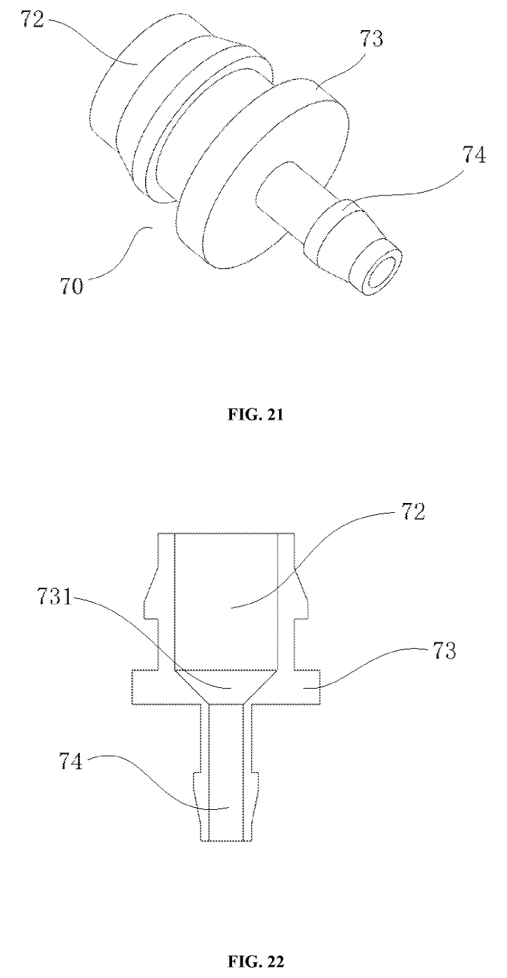

Please refer to FIGS. 18-22, the airbag assembly 20 is connected to the second air delivery pipes 55 through flexible connecting pipes 30, and a hollow spring member 50 is provided inside each of the connecting pipes 30, which extends along the direction of the connecting pipe 30 and has a length corresponding to the connecting pipe 30. The outer wall of the spring member 50 is in contact with the inner wall of the connecting pipe 30 to support the connecting pipe 30, thereby preventing the connecting pipe 30 from collapsing and preventing air from conducting.

Furthermore, the connecting pipe 30 and the second air delivery pipe 55 are connected by a connecting joint 70, and the inner diameter of the connecting pipe 30 is greater than that of the second air delivery pipe 55. The connecting joint 70 includes a first joint 74, a second joint 72, and a mounting plate 73, the first joint 74 is connected to the second air delivery pipe 55, and the second joint 72 is connected to the connecting pipe 30. One side of the mounting plate 73 is connected to the first joint 74, and the opposite side is connected to the second joint 72. There is a conical connecting hole 731 in the mounting plate 73, and one end of the connecting hole 731 is connected to the first joint 74 with a diameter corresponding to the inner diameter of the first joint 74; the other end of the connecting hole 731 is connected to the second joint 72 with a diameter corresponding to the inner diameter of the second joint 72.

Through the design of the above structure, even if the connecting pipe 30 is deformed by external forces, the cross-section of its internal channel can still maintain a large area and will not affect the normal flow of air. In addition, due to the conical connecting hole 731 provided on the mounting plate 73, the air in the airbag assembly 20 will be accelerated to a certain extent when it enters the second air delivery pipe 55 from the connecting pipe 30, so that the airbag assembly 20 can be more quickly discharged outward, facilitating rapid collection and reception.

The above descriptions are only preferred embodiments of the present disclosure, and are not intended to limit the patent scope of the present disclosure. Any equivalent structural transformation made by using the content of the specification and the drawings of the present disclosure under the invention idea of the present disclosure, directly or indirectly applied to other related technical fields, shall all be included in the scope of patent protection of the present disclosure.

What is claimed is:

1. A healthcare device, comprising:
a belt body, configured for wrapping around a user body;
an airbag assembly, wherein the airbag assembly is inflatable and deflatable, and comprises at least one first airbag arranged on the belt body, and at least one second airbag arranged on the at least one first airbag;
a control device arranged on the belt body and exposed to outside; and
an inflation and deflation component, arranged on the belt body and connected to the airbag assembly, the inflation and deflation component being configured for inflating or deflating the airbag assembly based on control of the control device.

2. The healthcare device according to claim 1, further comprising a vibration component arranged in the at least one second airbag, and the at least one second airbag is capable of wrapping around the vibration component after inflation.

3. The healthcare device according to claim 2, wherein a first fixing portion is provided on the first cover, and a second fixing portion is provided on the second cover, and the first fixing portion and the second fixing portion are configured to be detachably attached to each other when the belt body wraps around the user body.

4. The healthcare device according to claim 1, wherein the belt body comprises a first cover and an opposite second cover, the first cover and the second cover are made of flexible material, and the first airbag assembly and the second airbag assembly are mounted between the first cover and the second cover.

5. The healthcare device according to claim 1, wherein the at least one first airbag comprises two first airbags, and the two first airbags are in communication with each other.

6. The healthcare device according to claim 1, wherein the at least one second airbag comprises two second airbags, and the two second airbags are in communication with each other.

7. The healthcare device according to claim 1, wherein the at least one first airbag is in communication with the at least one second airbag.

8. The healthcare device according to claim 1, wherein the airbag assembly further comprises two third airbags arranged on the belt body, the at least one first airbag and the at least one second airbag are arranged at a middle of the belt body, and the two third airbags are arranged respectively on left and right of the at least one first airbag.

9. The healthcare device according to claim 1, wherein the inflation and deflation component comprises:
an air pump, electrically connected to the control device to work based on control of the control device;
a multi connector, comprising an air inlet and multiple air outlets, wherein the air inlet is connected to the air pump through a first air delivery pipe, and the air outlets each are connected to a second air delivery pipe, and the second air delivery pipes extending to the airbag assembly; and
multiple electromagnetic valves, each respectively installed on one of second air delivery pipes and electrically connected to the control device to work based on control of the control device.

10. The healthcare device according to claim 9, wherein the airbag assembly is connected to the second air delivery pipes through connecting pipes, and a hollow spring member is provided inside each of the connecting pipes, which extends along a lengthwise direction of the corresponding connecting pipe.

11. The healthcare device according to claim 9, wherein the connecting pipe and the second air delivery pipe are connected by a connecting joint, and an inner diameter of the connecting pipe is greater than that of the second air delivery pipe;
the connecting joint comprises a first joint, a second joint, and a mounting plate, the first joint is connected to the second air delivery pipe, and the second joint is connected to the connecting pipe;
one side of the mounting plate is connected to the first joint, and the opposite side is connected to the second joint; a conical connecting hole is provided in the mounting plate, and one end of the connecting hole is connected to the first joint with a diameter corresponding to an inner diameter of the first joint, the other end of the connecting hole is connected to the second joint with a diameter corresponding to an inner diameter of the second joint.

12. The healthcare device according to claim 1, further comprising a heating component arranged in the belt body, wherein the heating component comprises an electric heating wire and two heat-resistant fabric layers, the electric heating wire is arranged in a zigzag pattern and positioned between the two heat-resistant fabric layers, and the two heat-resistant fabric layers are bonded together.

13. The healthcare device according to claim 12, further comprising a thermal insulation component, the thermal insulation component forms part of the belt body, the heating component is sewn into the thermal insulation component, and the airbag assembly is arranged in the thermal insulation component.

14. The healthcare device according to claim 1, wherein the belt body further includes a connection seat, and the control device comprises a housing, a touch display screen, a circuit board, a power supply, a switch, and a charging port, the housing comprises a detachable upper housing and a lower housing, with the lower housing located between the upper housing and the belt body, and connected to belt body through a connection seat;
the touch display screen is arranged outside the upper housing, and the circuit board and power supply are arranged inside the housing; the switch and charging port are arranged on the circuit board and one end of each of the switch and charging port penetrates the housing, allowing user to perform switching and charging operations from outside of the housing.
